(19) United States
(12) Patent Application Publication
(10) Pub. No.: US 2016/0103506 A1
(43) Pub. Date: Apr. 14, 2016

(54) INPUT DEVICE, METHOD FOR CONTROLLING INPUT DEVICE, AND NON-TRANSITORY COMPUTER-READABLE RECORDING MEDIUM

(71) Applicant: FUJITSU LIMITED, Kawasaki-shi (JP)

(72) Inventor: Eiichi Matsuzaki, Koto (JP)

(73) Assignee: FUJITSU LIMITED, Kawasaki-shi (JP)

(21) Appl. No.: 14/975,955

(22) Filed: Dec. 21, 2015

Related U.S. Application Data
(63) Continuation of application No. PCT/JP2013/068177, filed on Jul. 2, 2013.

(51) Int. Cl. G06F 3/0346; G06F 3/0485

(52) U.S. Cl. CPC G06F 3/0346; G06F 3/0485

(57) ABSTRACT

An input device includes a movement detector that detects a tilt of the input device during an input of information corresponding to a gesture operation, and a controller that executes a control to continue the input of information after the gesture operation, until the tilt detected by the movement detector becomes a predetermined status.

### CROSS-REFERENCE TO RELATED APPLICATIONS

This application is a U.S. continuation application filed under 35 USC 111(a) claiming benefit under 35 USC 120 and 365(c) of PCT application PCT/JP 2013/068177, filed on Jul. 2, 2013. The foregoing applications are hereby incorporated herein by reference.

### FIELD

The embodiments discussed herein are related to an input device, a method for controlling an input device, and a non-transitory computer-readable recording medium.

### BACKGROUND

An input device including a touch panel or the like allows input of information corresponding to an operation performed on the touch panel by the user. For example, the input device allows a user to input information, scroll contents or the like displayed on a screen, and switch applications according to the user's gesture (e.g., swiping, flicking) performed on the touch panel.

Further, various sensors such as a tilt sensor or a sensor are provided in the input device, so that the user can perform a method of, for example, scrolling of contents displayed on a screen by tilting or shaking the input device. Further, a lock button is provided as a hardware structure of the input device, so that the input device can be switched on/off according to a sensor controlled by pressing of the lock button. Further, there is a method of preventing a user from performing an unintended operation by allowing user's control only when the input device is in a position that is unlikely to occur during regular usage. Further, there is a method of consecutively flipping pages when an information device is tilted when operating on a touch panel (see, for example, Patent Documents 1 to 3).

### RELATED ART DOCUMENT

Patent Document 1: Japanese Laid-Open Patent Publication No. 2012-140159
Patent Document 2: Japanese Laid-Open Patent Publication No. 2011-253493
Patent Document 3: Japanese Laid-Open Patent Publication No. 10-161619

However, with the conventional input device, a swiping operation is to be repeatedly performed on a touch panel for continuously performing a movement such as scrolling. Further, in a case where input is controlled by a sensor, the user may perform an unintended operation when the sensor makes an erroneous detection or when the sensor does not define a movement target. An additional hardware button or an irregular movement that is different from a usual movement may be required for preventing a user from performing an intended movement. The term “irregular movement” may refer to, for example, a movement of making a screen difficult to view for the user or maintaining a horizontal state.

### SUMMARY

According to an aspect of the invention, there is provided an input device including a movement detector that detects a tilt of the input device during an input of information corresponding to a gesture operation, and a controller that executes a control to continue the input of information after the gesture operation until the tilt detected by the movement detector becomes a predetermined status.

The object and advantages of the invention will be realized and attained by means of the elements and combinations particularly pointed out in the claims.

It is to be understood that both the foregoing general description and the followed detailed description are exemplary and explanatory and are not restrictive of the invention, as claimed.

### BRIEF DESCRIPTION OF DRAWINGS

FIG. 1 is schematic diagram illustrating a functional configuration of an input device according to an embodiment of the present invention;

FIG. 2 is a schematic diagram illustrating a hardware configuration of an input device according to an embodiment of the present invention;

FIG. 3 is a flowchart illustrating an input control process of an input device according to a first embodiment of the present invention;

FIG. 4 is a schematic diagram for describing an example of an input operation of an input control process according to the first embodiment of the present invention;

FIG. 5 is a schematic diagram illustrating a specific example in a case where multiple scroll screens exist in a single screen;

FIG. 6 is a schematic diagram illustrating an example of content of correction by a correction part;

FIG. 7 is a schematic diagram illustrating an example of status change of input control of an input device (part 1);

FIG. 8 is a schematic diagram illustrating an example of status change of input control of an input device (part 2);

FIG. 9 is a schematic diagram illustrating an example of status change of input control of an input device (part 3);

FIG. 10 is a flowchart illustrating an input control process of an input device according to a second embodiment of the present invention;

FIG. 11 is a schematic diagram for describing an example of an input operation of an input control process according to the second embodiment of the present invention; and

FIGS. 12A-12C are schematic diagrams illustrating examples of kinds of controls, gestures, and sensors that are applicable.

### DESCRIPTION OF EMBODIMENTS

Next, embodiments of the present invention are described with reference to the accompanying drawings.

<Functional Configuration of Input device>

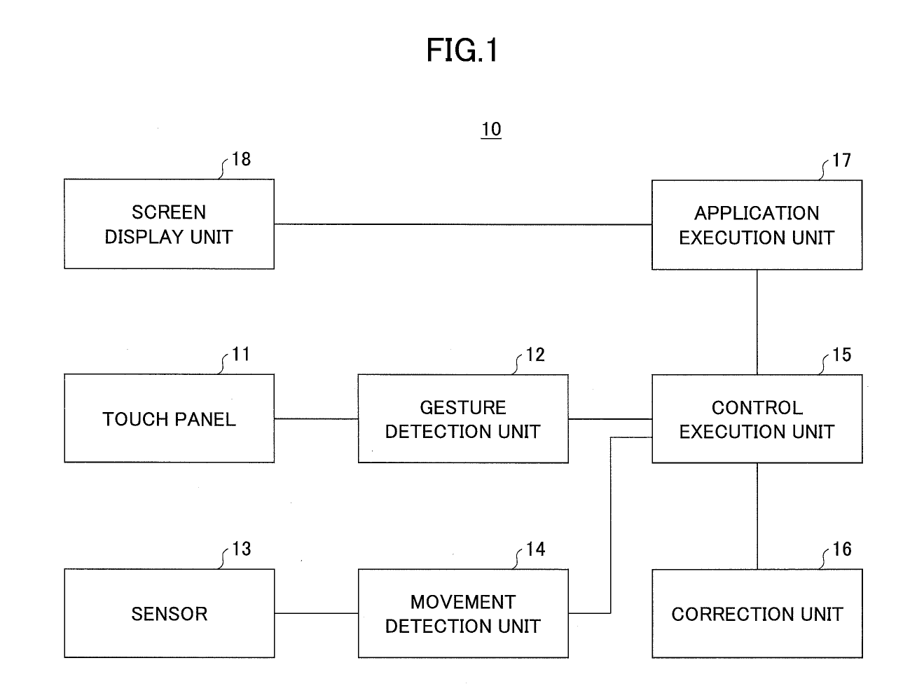

FIG. 1 is schematic diagram illustrating a functional configuration of an input device according to an embodiment of the present invention. An input device 10 illustrated in FIG. 1 is an information device that performs, for example, input control. The input device 10 includes a touch panel 11, a gesture detection unit 12, a sensor 13, a movement detection unit 14, a control execution unit (controller) 15, a correction unit 16, an application execution part 17, and an a screen display unit 18.

The touch panel 11 is an input unit for inputting various information in the input unit 100. The touch panel 11 obtains position data of a finger or the like by detecting a fine current flowing from a user's finger contacting a screen or by detecting pressure exerted from a touch pen. The touch panel 11 may detect the position of a finger, a pen or the like by using, for example, a resistive membrane method, a capacitive sensing method, an infrared method, or an electromagnetic induction method.

The touch panel 11 can simultaneously obtain the positions of multiple fingers or the like. Further, the touch panel 11 can obtain input information by tracing the movement of a finger along with the passing of time. In a case where various contents such as icons, operation buttons, operation levers, Web pages are displayed on a screen, the touch panel 11 may obtain corresponding input information according to a relationship between a contact position of the finger and a position in which the contents are displayed.

Further, the touch panel 11 may be, for example, a touch panel display that is integrally formed with a display (screen display unit 18). The control content (e.g., scroll) based on information input from the touch panel 11 is displayed on the screen display unit 18.

The gesture detection unit 12 detects a gesture content based on the movement of the user's finger or the like detected from the touch panel 11. For example, in a case where the gesture detection unit 12 detects that a touch operation is performed on the touch panel 11 with the user's finger or the like, the gesture detection unit 12 obtains input information such as the position of the touch, the number of times of touches, and the movement direction of the finger.

Note that the gesture detection unit 12 not only may obtain movement content according to a position of the finger of an instant of a certain timing but may also track the movement of the finger along with the passing of time at intervals of a few seconds and obtain movement content according to the tracked content (movement path). Thereby, various gestures such as a swiping movement (e.g., a movement of sliding a finger in a state contacting a screen), another swiping movement (e.g., a movement of light flicking a screen), a tapping movement, or a movement of rotating a finger on a screen can be detected.

The gesture detection unit 12 can detect, for example, a swiping operation (gesture) together with an operation time (timing). The gesture detection unit 12 can detect a gesture based on, for example, the content displayed on the screen display unit 18, the position of an icon, the position or the path of the movement of one or more fingers detected from the touch panel 11. Therefore, even in a case where the same movement is detected from the user, gesture detection unit 12 can detect different gestures according to, for example, the group of buttons, the content, or the kind of contents that are displayed on the screen display unit 18.

The sensor 13 obtains information such as the tilt of the screen, the acceleration, and the current position of the input device 10. Note that, although the sensor 13 of this embodiment includes one or more kinds of sensors such as a tilt sensor, an acceleration sensor, and a gyro sensor, the sensor 13 include other sensors. Further, in a case of obtaining position information of the input device 10, the sensor 13 may also include a GPS (Global Positioning System) function or the like.

The movement detection unit 14 detects the movement of the input device 10 based on information obtained from the sensor 13. Note that the movement detection unit 14 not only may obtain the movement of the input device 10 from the sensor 13 at a certain timing but may also track the movement of the input device 10 for a few seconds and determine the movement of the input device 10 according to the tracked movement (status) of the input device 10. Therefore, this embodiment allows detection of movement such as rotating the input device 10, shaking the input device right and left, or moving the input device 10 back to its initial position after moving the input device in a given direction.

The control execution unit 15 executes a control corresponding to respective detection results obtained from the gesture detection unit 12 and the movement detection unit 14. For example, the control execution unit 15 controls, for example, on/off switching or the operation of the application displayed on the screen display part 18 according to the detection results from the gesture detection unit 12 and the movement detection unit 14.

Note that the control execution unit 15 may measure the time elapsed from the start of a gesture detected by the gesture detection unit 12 and perform a control corresponding to the movement of the input device detected by the movement detection unit 14 when the measured time has reached a predetermined time.

The control execution unit 15, in accordance with the information input by the user's movement detected by the gesture detection unit 12, performs various controls on, for example, selecting/moving of an icon or a button displayed on the screen display unit 18, scrolling of contents, selecting of input areas (e.g., check box, text box) included in the contents, and inputting of characters. The control execution unit 15 performs the various controls byway of applications (also referred to “appli” according to necessity) included in the application execution unit 17.

In a case where the control execution unit 15 performs control based on the detection results of the sensor 13, the control execution unit 15 may limit its amount of control to a predetermined proportion. Further, the control execution unit 15 may change the proportion of the amount of control based on the detection results of the sensor 13 in accordance with the size (amount) of the gesture operation.

The control execution unit 15 may continue input after the gesture operation until, for example, the tilt obtained by the movement detection unit 14 becomes a predetermined state (e.g. a state where the tilt returns to an initial tilt). However, the condition for continuing the input is not limited to the above.

The correction unit 16 corrects, for example, a criterion value (e.g., tilt information) of a sensor control by cooperating with the control execution unit 15. The content of the correction by the correction unit 16 may be, for example, correcting of angle in a case of determining whether the tilt of the input device 10 is within a predetermined range or correcting or correcting position information of an end part of a screen in a case of determining whether a finger is performing an operation at the vicinity of the end part of the screen. However, the content of correction by the correction unit 16 is not limited to the above.

Multiple various applications that can be executed by the input device 10 are stored beforehand in the application execution unit 17 (e.g., pre-installed). The application execution unit 17 executes a predetermined appli corresponding to the content of the control by the control execution unit 15. Note that the appli maybe software for document editing or spreadsheet calculation. Further, the appli may be a basic application for performing basic operations such as scrolling or changing a screen, activating a browser, activating/terminating/switching an application in response to a swiping movement or a clicking movement. The various applications may be executed on an Operating System (OS) such as Android (registered trademark), Windows (registered trademark). However, the various application may be executed on programs or operating systems other than the above.

The screen display unit 18 is an output unit that displays contents on a screen. The contents that are displayed are obtained from an application executed by the application execution unit 17. Note that the screen display unit 18 may be integrated with the touch panel 11. In this case, the touch panel 11 and the screen display unit 18 constitute an integrated input/output unit.

The input device 10 of this embodiment may be used for information devices such as a tablet, a smartphone, a Personal Digital Assistant (PDA), or a mobile phone. Further, the input device 10 may also be used for information devices such as a personal computer (PC), a server, a game device, a music player.

As described above, the input device 10 of this embodiment is an information device including both the touch panel 11 and the sensor 13. Thus, the input device 10 may continue to control the movement of a gesture based on a gesture performed on the touch panel 11 with a finger and the movement of the input device 10. For example, with the input device of this embodiment, a screen may be scrolled by the user's swiping movement performed on the touch panel 11 while the input device 10 is tilted, so that the scrolling can be continued to be executed. Accordingly, the operability of the user's input performed on the input device 10 can be improved.

In this embodiment, the controls executed by the control execution unit 15 are set to instruct the application execution unit 17 to execute various applications. However, the execution of applications is not limited to the above. For example, the output of the gesture detection unit 12 and the movement detection unit 14 may be output to the application execution unit 127, so that the application execution unit 17 controls execution of various applications. In this embodiment, the various application that are controlled and the control execution unit 15 may together constitute a single body. Alternatively, the various application and the control execution unit 15 may be separate components.

### <Hardware Configuration of Input Device 10>

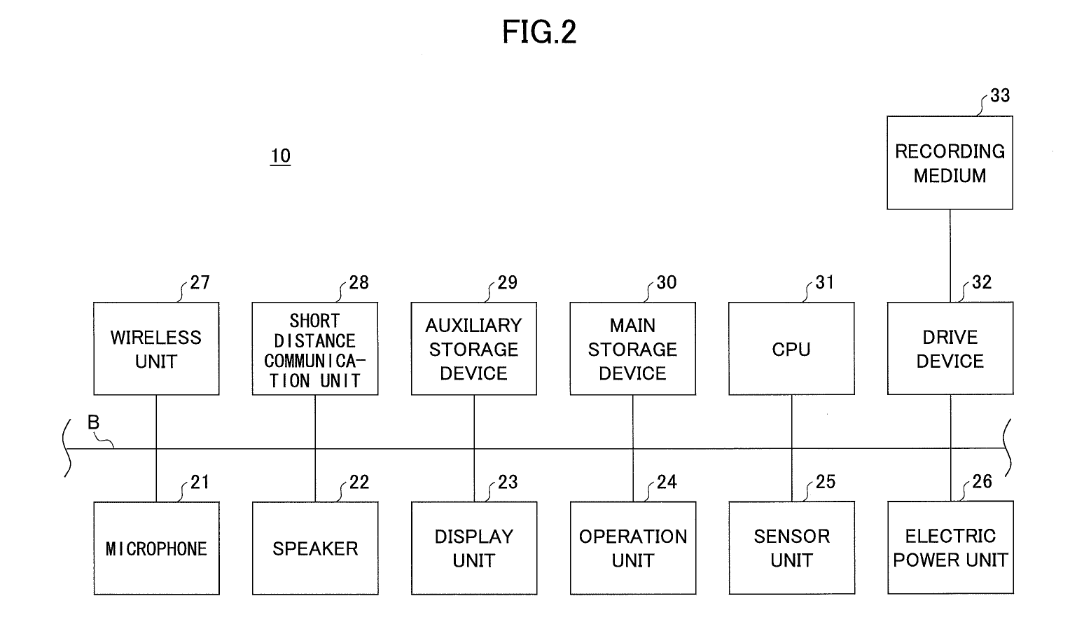

FIG. 2 is a schematic diagram illustrating an example of a hardware configuration of the input device 10 according to an embodiment of the present invention. In the example illustrated in FIG. 2, the input device 10 includes a microphone (hereinafter referred to as “mic”) 21, a speaker 22, a display unit 23, an operation unit 24, a sensor unit 25, an electric power unit 26, a wireless unit 27, a short distance communication unit 28, an auxiliary storage device 29, a main storage device 30, a processor (Central Processing Unit (CPU)) 31, and a drive device that are connected to each other by a bus B.

The microphone 21 inputs a user's voice and other sounds. The speaker 22 outputs a voice of a communication opponent or a sound such as a ring tone. Although the mic 21 and the speaker 22 may be used for conversing with an opponent by way of a telephone function, the mic 21 and the speaker 22 maybe used for other purposes such as inputting and outputting information by voice.

The display unit 23 includes a display such as a Liquid Crystal Display (LCD) or an organic Electro Luminescence (EL) display. The display unit 23 may also be a touch panel display including the touch panel 11 and the screen display unit 18.

The operation unit 24 includes, for example, the touch panel 11 and operation buttons provided on an external part of the input device 10. The operation buttons may include, for example, a power button, a volume adjustment button, and other operation buttons. The operation unit 24 may include, for example, operation buttons for switching on/off the power of the input device 10, adjusting the volume output from the speaker 22 or the like, and inputting characters.

In a case where, for example, the user performs a predetermined operation on a screen of the display unit 23 or presses the operation button, the display unit 23 detects a touch position on the screen or a gesture (e.g., swiping movement) performed on the screen. The display unit 23 also displays information such as an application execution result, contents, or an icon on the screen.

The sensor unit 25 detects movement performed on the input device 10 at a certain timing or movement continuously performed on the input device 10. For example, the sensor unit 25 detects the tilt angle, acceleration, direction, and position of the input device 10. However, the sensor unit 25 is not limited to detecting the above. The sensor unit 25 of this embodiment may be a tilt sensor, an acceleration sensor, a gyro sensor, or a GPS. However, the sensor unit 25 is not limited to these sensors.

The electric power unit 26 supplies electric power to each of the components/parts of the input device 10. The electric power unit 26 in this embodiment may be an internal power source such as a battery. However, the electric power unit 26 is not limited to a battery. The power unit 26 may also detect the amount of power constantly or intermittently at predetermined intervals and monitor, for example, the remaining amount of electric power.

The wireless unit 27 is a transmission/reception unit of communication data for receiving wireless signals (communication data) from a base signal using an antenna or the like and transmitting wireless signals via an antenna or the like.

The short distance communication unit 28 performs short distance communication with another device by using a communication method such as infrared communication, Wi-Fi (registered trademark) or Bluetooth (registered trademark). The wiring unit 27 and the short distance communication unit 28 are communication interfaces that enable transmission/reception of data with another device.

The auxiliary storage device 29 is a storage unit such as a Hard Disk Drive (HDD) or a Solid State Drive (SSD). The auxiliary storage device 29 stores various programs and the like and inputs/outputs data according to necessity.

The main storage device 30 stores execution programs or the like read out from the auxiliary storage device 29 according to instructions from the CPU 31 and also stores various information obtained during the execution of a program or the like. The main storage device 30 in this embodiment is a Read Only Memory (ROM) or a Random Access Memory (RAM). However, the main storage device 30 is not limited to these memories.

The CPU 31 implements various processes for controlling input by controlling the processes of the entire computer (e.g., various calculations, data input/output of each hardware component) based on a control program (e.g., OS) and an execution program stored in the main storage device 30. The various information required during the execution of a program may be obtained from the auxiliary storage device 29 and the results of the execution of the program may be stored in the auxiliary storage device 29.

The drive device 32 can be detachably attached with, for example, the recording medium 33 to read various information recorded on the recording medium 33 and write predetermined information on the recording medium 33. The drive device 32 in this embodiment is a medium installment slot. However, the drive device 32 is not limited to the above.

The recording medium 33 is a computer-readable recording medium on which the execution program or the like is recorded. The recording medium 33 may be, for example, a semiconductor memory such as a flash memory. The recording medium 33 may also be a portable type recording medium such as a Universal Serial Bus (USB). However, the recording medium 33 is not limited to the above.

In this embodiment, processes such as the display process can be implemented with the cooperation of hardware resources and software by installing an execution program (e.g., input control program) in the above-described hardware configuration of the computer body. Further, the input control program corresponding to the above-described display process may be reside in the input device or be activated in response to an activation instruction.

For example, the input device 10 of this embodiment maybe implemented by using a device installed with an integrated type touch panel display and software that operates on the device. A part of the software may be implemented by a hardware device having an equivalent function as the software.

### <Process of Input Device 10>

Next, an example of a process of the input device 10 according to an embodiment of the present invention is described by using a flowchart. In the following description, a swiping movement is described as an example of a gesture movement performed on the input device 10 by the user. However, the gesture movement is not limited to this example. The gesture movement maybe, for example, a flicking movement or any other movement that is set beforehand for executing a predetermined action or movement (e.g., scrolling of contents on a screen).

### First Embodiment of Input Control Process

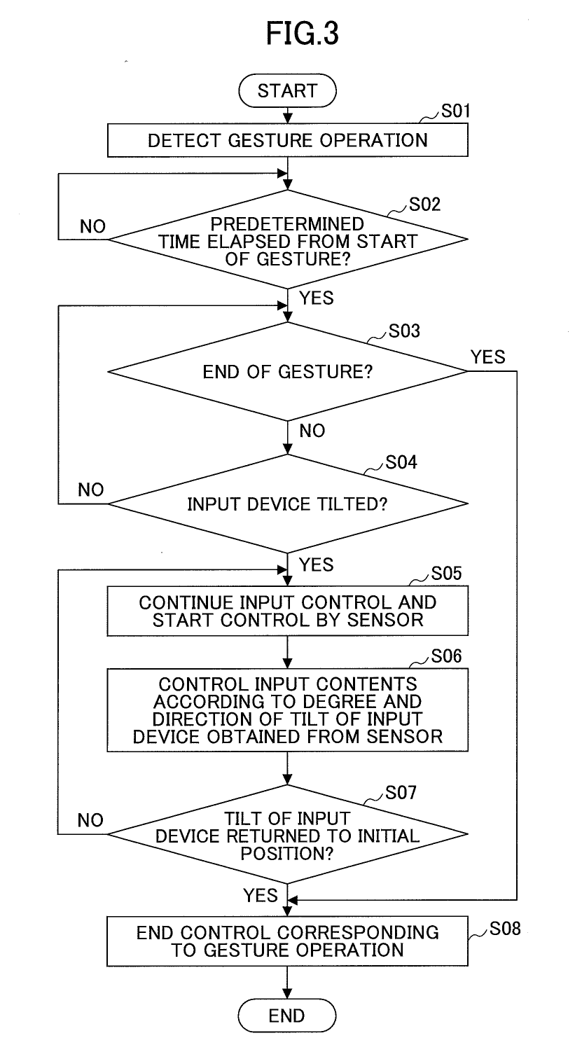

FIG. 3 is a flowchart illustrating an input control process of the input device 10 according to a first embodiment of the present invention. In the embodiment of FIG. 3, the input device 10, in response to the user's input on the touch panel 11, detects a gesture movement (e.g., swiping operation) byway of the gesture detection unit 12 (S01). Although the embodiment of FIG. 3 illustrates an example of the input control process, in reality, the control execution unit 15 performs an application movement (e.g., scrolling) corresponding to a gesture operation when the gesture operation is detected. Further, the control execution unit 15 measures the time starting from the gesture movement.

Then, the control execution unit 15 determines whether a predetermined time has elapsed from the start of the gesture operation (S02). In a case where a predetermined time has not elapsed (NO in S02), the process of S02 continues until the predetermined time has elapsed. Note that a movement (e.g., scrolling) corresponding to the contents or the like displayed on the screen display unit 18 in response to the gesture operation is continued during this time. The control execution unit 15 may perform a control to adjust the movement speed of, for example, the contents or the like displayed on the screen display unit 18 according to the speed of the user's gesture operation.

In a case where a predetermined time has elapsed (YES in S02), the control execution unit 15 determines whether the gesture has ended (S03). In a case where the gesture has not ended (NO in S03), the control execution unit 15 determines whether the input device 10 is tilted (S04). Note that the tilt of the input device 10 can be obtained from the movement detection unit 14. For example, the control execution unit 15 determines whether the input device 10 is tilted at an angle greater than or equal to a predetermined angle α relative to a horizontal plane or a reference plane (e.g., tilt plane at the start of a gesture operation).

In a case where the control execution unit 15 determines that the input device 10 is not tilted (NO in S04), the control execution unit 15 returns to the process of S03. That is, the control execution unit 15 continues the movement corresponding to the gesture operation until the gesture has ended. In a case where the control execution unit 15 determines that the input device 10 is tilted at an angle greater than or equal to a predetermined angle α (YES in S04), the control execution unit 15 starts control of the sensor 13 while still continuing the movement corresponding to the gesture operation (S05).

Then, the control execution unit 15 controls, for example, the input content in accordance with the angular degree (tilt) and orientation of the input device 10 obtained from the sensor 13 (S06). Note that the tilt of the input device 10 can be obtained by the movement detection unit 14. For example, the movement detection unit 14 determines whether the input device 10 is positioned at an angle greater than or equal to a predetermined angle α relative to the horizontal plane or the reference plane (e.g., tilt plane at the start of an operation gesture).

In a case where the input device 10 is not tilted (NO in S04), the control execution unit 15 returns to the process of S03. That is, the control execution unit 15 continues the movement corresponding to the gesture operation until the gesture has ended. Further, in a case where the input device 10 is tilted to an angle greater than or equal to the predetermined angle α (YES in S04), the control execution unit 15 starts control of the sensor 13 while still continuing the movement corresponding to the gesture operation (S05).

Then, the control execution unit 15 controls, for example, the input content in accordance with the angular degree (tilt) and orientation of the input device 10 obtained from the sensor 13 (S06). Note that the control execution unit 15 is preferred to execute the control in a manner similar to the control content executed at the time of the controlling the movement corresponding to the gesture operation of the user. Thereby, the control of the movement responsive to the gesture and the control of the movement according to the information obtained from the sensor 13 can seamlessly continue.

For example, in a case where the angle detected by the movement detection unit 14 is greater than the reference angle (assuming that the tilt of the input device 10 at the time of starting the process of S05 is the reference angle), the control execution unit 15 can perform movement control according to the difference of the amount of the detected angle or the difference of the tilt of the input device 10. Further, in a case where the angle detected by the movement detection unit 14 is less than the tilt of the input device 10 at the time of starting the process of S05 (reference angle), the control execution unit 15 may control the scrolling movement into another direction (upward direction) that is opposite to the direction of the scrolling movement at that time (downward direction).

Then, the control execution unit 15 determines whether the tilt of the input device 10 has returned to its initial position (e.g., angle obtained at the time of starting the control of the sensor 13) (S07).

In a case where the tilt of the input device 10 has not returned to its initial position (NO in S07), the control execution unit 15 returns to the process of S05. Further, in a case where the tilt of the input device 10 has returned to its initial position (YES in S07) or when the gesture has ended in S03 (YES in S03), the control corresponding to the gesture is ended (S08), and the input control process is terminated.

With the above-described first embodiment, a movement corresponding to a gesture can be controlled to continue by moving the input device 10 at an appropriate timing during detection of the gesture by providing both the touch panel 11 and the sensor 13. For example, in a case where a screen is scrolled by swiping the touch panel 11, the screen can continue to scroll according to the input from the sensor 13 by tilting the input device 10 during the scrolling movement without having to repeating the swiping operation. Thereby, the operability of a user's input to the input device 10 can be improved.

### Example of Input Operation According to Input Control Process of First Embodiment

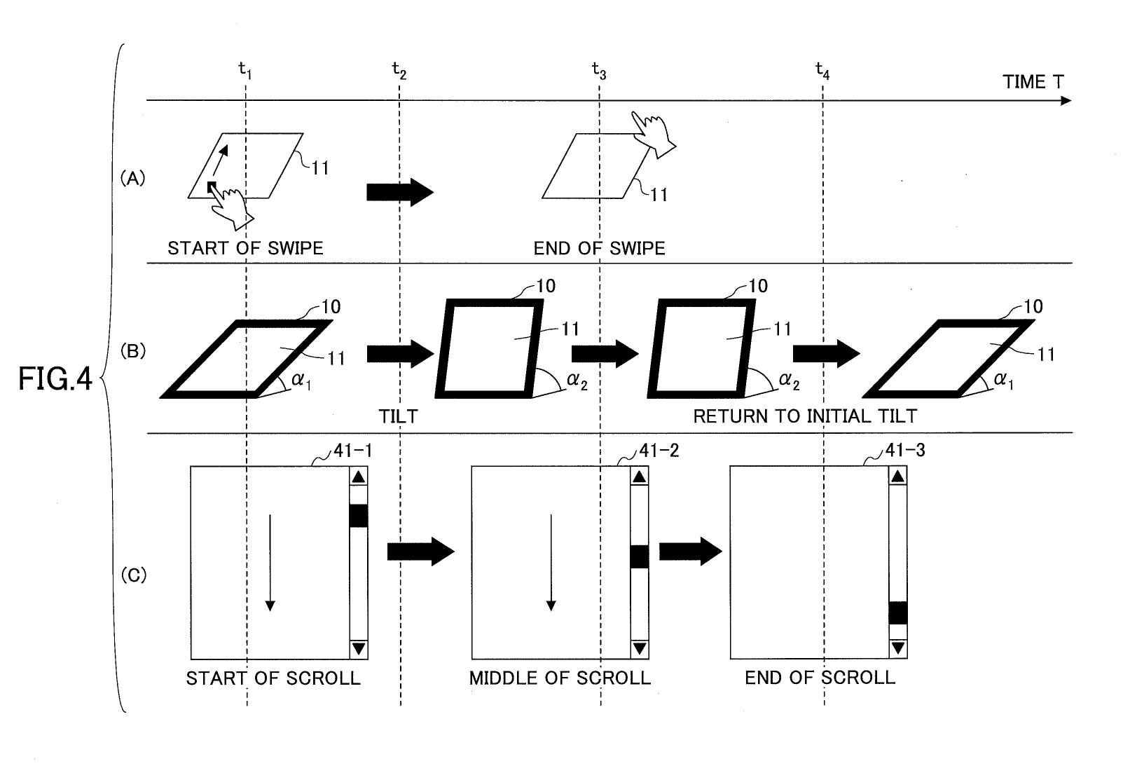

FIG. 4 is a schematic diagram for describing an example of an input operation according to the input control process of the first embodiment. (A) of FIG. 4 illustrates an example of a user's operation with respect to the touch panel 11 of the input device 10, (B) of FIG. 4 illustrates an example of a user's operation with respect to the input device 10, (C) of FIG. 4 illustrates an example of a contents screen 41 displayed on the screen display unit 18.

Note that, although (A) to (C) of FIG. 4 illustrate operations and movement occurring from time t₁ to t₄ during the same time period T, the operations and movement are not limited to the operations and movement illustrated in FIG. 4.

When the user swipes the touch panel 11 as illustrated in (A) of FIG. 4 (time t₁), a contents screen 41-1 scrolls in a downward direction in response to the swiping operation as illustrated in (C) of FIG. 4.

In the example of FIG. 4, the input device 10 is tilted at an angle greater than or equal to a predetermined angle (e.g., α₂) relative to the current reference angle (e.g., α₁) in a predetermined direction (e.g., scrolling direction) during the swiping operation (time t₂). The input device 10 detects the swiping operation performed on the touch panel 11 for a predetermined time (e.g., time t₂-t₁) and the tilting movement of the input device 10 in a predetermined direction (e.g., tilt angle α₂-α₁).

Thereby, the control execution unit 15 continues the scrolling of the contents screen 41-2 even after the swiping operation has ended (time t₃) as illustrated in (B) of FIG. 4. Further, when the tilt of the input device 10 is returned to its initial position (e.g., angle α2 to α1) (time t₄), the scrolling of the contents screen 41-3 is ended as illustrated in (C) of FIG. 4

For example, in a case of only performing the swiping operation without tilting the input device 10, the control execution unit 15 starts the scrolling of the screen when the swiping on the touch panel 11 is started. In this case, when the swiping operation has ended before a predetermined time has elapsed, the scrolling of the screen is ended regardless of the tilt of the input device 10.

With the above-described input control process, the user does not need to repeat the swiping operation for continuing the scrolling movement. For example, a scrolling movement or the like can be continued without having to repeat a swiping gesture. Further, with the first embodiment, because a continuous control is implemented by the control of a sensor, a movement that is not intended by the user can be avoided. Further, the input device 10 requires no additional hardware button, and the screen display unit 18 does not need to be excessively tilted. Therefore, the input device 10 can be maintained in an easily viewable state. With the above-described input control process, the control of the sensor 13 can be triggered by the operation of the touch panel 11.

### <Case of Multiple Scroll Screens>

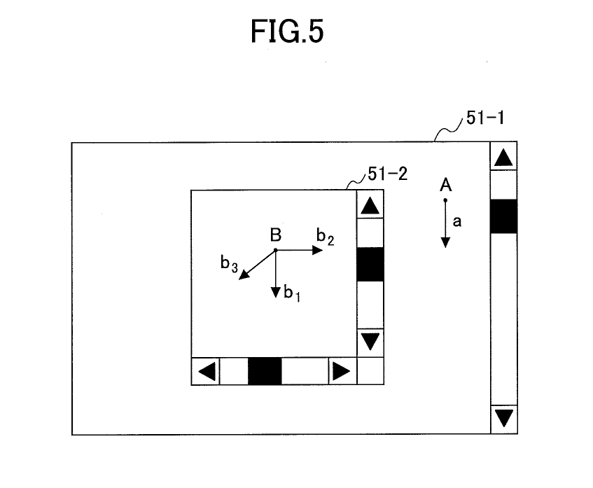

Next, a case where multiple scroll screens are provided in a single screen is described with reference to the drawings. For example, FIG. 5 illustrates an exemplary case where multiple scroll screens are provided within a single screen. In the example of FIG. 5, a contents screen 51-1 displayed on the screen display unit 18 includes contents that enable scrolling in a vertical direction. A contents screen 51-2 provided within the contents screen 51-1 includes contents that enable scrolling in a vertical direction, a horizontal direction, and a diagonal direction. In this case, the control execution unit 15 sets the target contents that are to be controlled to scroll in accordance with a touch position (start point) of a starting gesture.

For example, in a case where the gesture is a swiping operation starting from a start point A in an arrow “a” direction, the contents screen 51-1 scrolls in an upward direction as illustrated in FIG. 5. Further, in a case where the gesture is a swiping operation starting from a start point B in an arrow “b₁” direction, the contents screen 51-2 scrolls in an upward direction as illustrated in FIG. 5. Further, in a case where a swiping operation is performed from the start point B in an arrow “b₂” direction, the contents screen 51-2 scrolls in a leftward direction. Further, in a case where a swiping operation is performed from the start point B in an arrow “b₃” direction, the content screen 51-2 is scrolled in a diagonal direction (diagonally upward direction) that includes vertical and horizontal directions.

Accordingly, the control execution unit 15 can determine, for example, the target contents to be controlled in accordance with the position of a start point at the time of starting a gesture.

In this embodiment, the tilt in the scrolling direction can be detected during a scroll control performed according to a swiping operation, so that input can be controlled to continue until the tilt detected after the scrolling operation returns to its initial state.

In this embodiment, a control corresponding to a swiping operation can be continued even after the swiping operation by tilting the input device 10 during the swiping operation at a predetermined angle in a direction corresponding to the direction (directions of arrows “a”, “b₁”, “b₂”, “b₃” in FIG. 5) of the swiping operation.

Depending on the contents displayed on the screen display unit 18, the scrolling operation may be performed only in the vertical direction as the contents screen 51-1 illustrated in FIG. 5 or only in the diagonal direction (including horizontal and vertical directions) as the contents screen 51-2. Therefore, the control execution unit 15, first, obtains information of the contents executed by the application execution unit 17 and displayed on the screen. Then, the control execution unit 15 determines whether the contents being displayed can be scrolled in the vertical direction, the horizontal direction, or the diagonal direction. Then, the control execution unit 15 performs input control according to the direction in which the contents can be scrolled (scrollable state).

The contents executed by the application execution unit 17 and displayed on the screen may be, for example, a Web page displayed on the screen by a browser application, a photograph image displayed on the screen by a camera application, or an e-mail displayed on the screen by a mail application. However, the contents executed by the application execution unit 17 and displayed on the screen are not limited to the above. As other examples, the contents may be an icon, an operation button, or an operation lever to be displayed on the screen display unit 18.

### <Contents of Correction by Correction Unit 15>

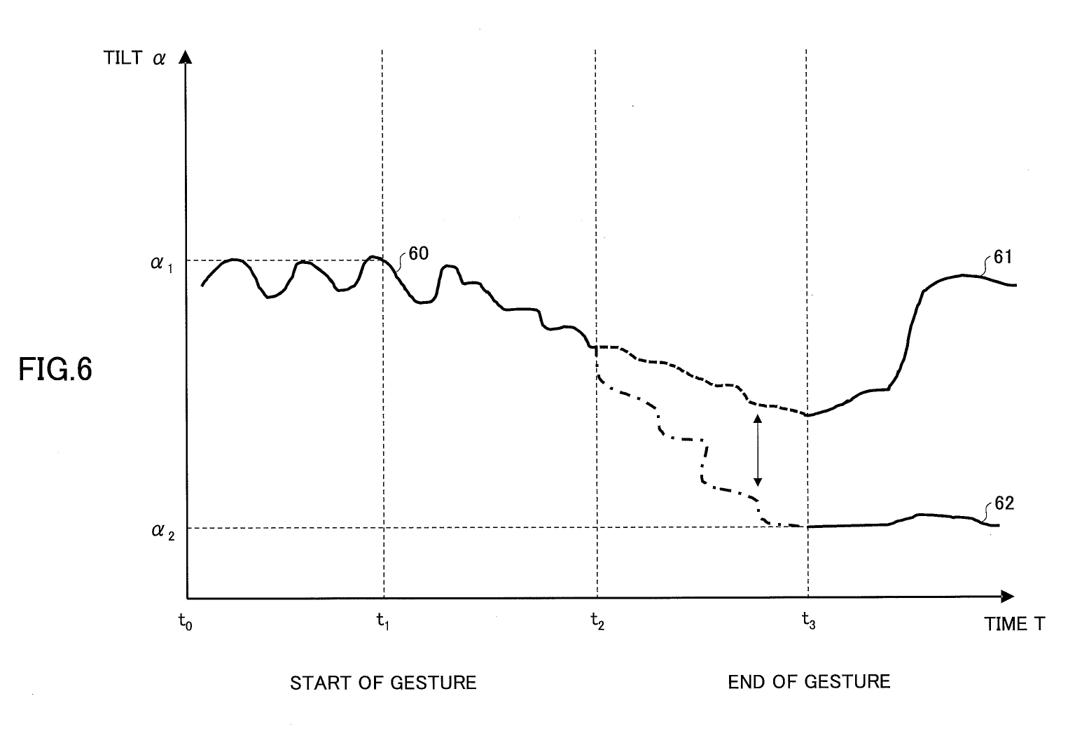

Next, an example of a correction process performed by the correction unit 16 is described with reference to the drawings. FIG. 6 is a schematic diagram illustrating an example of a correction process performed by the correction unit 16. In FIG. 6, the horizontal axis indicates time “T” and the vertical axis indicates the tilt “a” of the input device 10.

For example, in a case where the user uses a tablet or the like as the input device 10, the tilt of the input device 10 changes when the user is moving or riding on a train. Therefore, as illustrated in time “t₁” of FIG. 6, the tilt of the input device 10 may change even before the user starts a gesture due to, for example, wobbling of the input device 10 or noise of the sensor (line 60 of FIG. 6).

Further, the control execution unit 15 of this embodiment performs movement detection of the input device 10 according to information obtained from the sensor 13 when the start of a gesture operation is detected. In a case where the input device 10 is tilted to a predetermined angle, the input control caused by the gesture operation continues even after the gesture operation has ended. In this state, even if the user does not intend to tilt the input device 10 during the gesture operation, the tilt of the input device 10 maybe detected due to, for example, movement of the user or noise of the sensor 13 as illustrated in FIG. 6 (line 61 of FIG. 6).

Therefore, when the tilt of the input device 10 is detected, the correction unit 16 performs correction of one or more conditions to prevent the input control from being continued due to the input device 10 being unintentionally tilted by the user. For example, the correction unit 16 measures the continuation time of a gesture operation from the time when the gesture operation is started (gesture start time “t₁”). Then, the correction unit 16 corrects the tilt required for continuing the input control (“α₂” of FIG. 6) according to the measured time. Further, the correction unit 16 may detect the movement (tilt) of the input device 10, for example, from the gesture start time “t₁” to a predetermined time (time “t₂” of FIG. 6) and correct the tilt required for continuing the input control (“α₂” of FIG. 6) according to the detected movement (tilt). The information of the corrected tilt is output to the control execution unit 15.

Thereby, information indicating whether the input device 10 is intentionally tilted by the user (line 62 of FIG. 6) can be appropriately obtained. Thus, the above-described erroneous detection of tilt due to, for example, wobbling of the input device 10 or noise of the sensor 13 can be prevented. For example, in this embodiment, the control of the sensor 13 is not started in a case where the time of a gesture is short whereas the control of the sensor 13 is started in a case where the time of a gesture is greater than or equal to a predetermined time. Further, in this embodiment, even in a case where the position of the input device 10 is unintentionally changed in association with a gesture of the user, the movement of the input device 10 that is intended by the user can be detected by subtracting the amount of the change of the input device 10 associated with the gesture of the user from the amount of change of the movement of the input device 10.

### <Transition of Status of Input Control by Gesture Detection and Movement Detection>

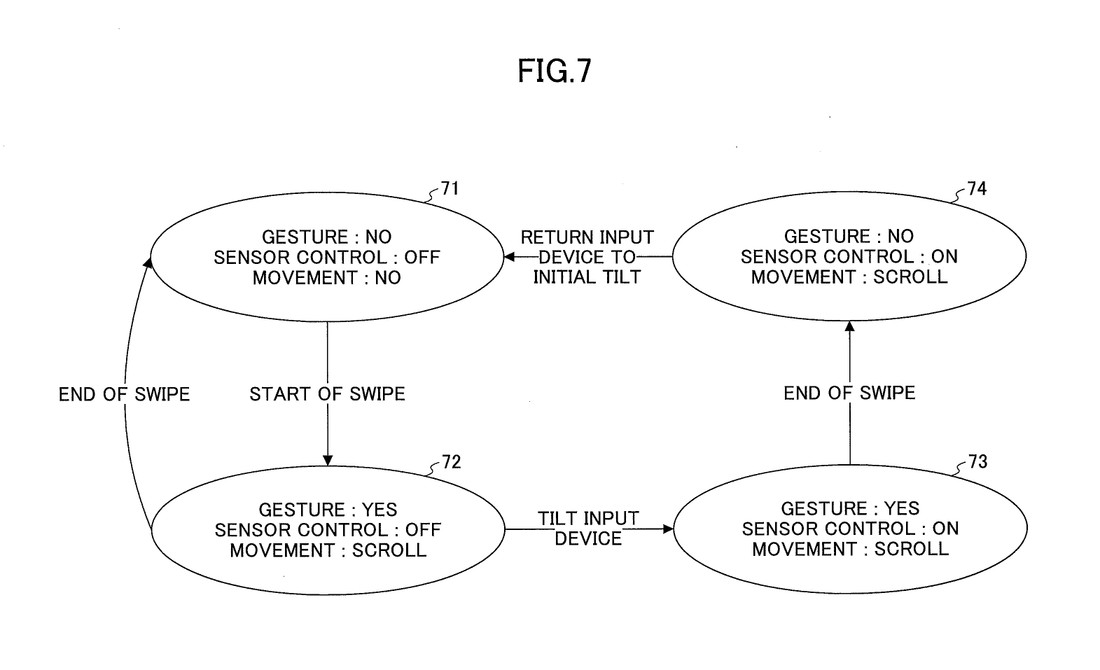

Next, the transition of the status of the input control process using the gesture detection by the touch panel 111 and the movement detection by the sensor 13 is described. FIGS. 7 to 9 are schematic diagrams illustrating examples of the transition of the status of the input control process with the input device 10.

In the examples of FIGS. 7 to 9, the items “gesture”, “sensor control”, and “movement” are set to each of the statuses 71-74. The item “gesture” indicate whether there is a user's gesture operation performed on the touch panel 11 (YES or NO). The item “sensor control” indicates whether the continuation of an input control equivalent to a gesture operation corresponding to the movement detected by the sensor is on (ON or OFF). The item “movement” indicates the content of the movement of the contents displayed on the screen display unit 18. Note that the item “movement” indicates only the movement corresponding to a gesture operation or control of the sensor 14 (sensor control).

In the example of FIG. 7, the initial status 71 is set as “gesture: NO”, “sensor control: OFF”, and “movement: NO” at the start of input control. When a user's gesture operation such as a swiping is started, the status 71 of the input control becomes “gesture: YES”, “sensor control: OFF”, and “movement: NO”) as illustrated in the status 72. When the swiping has ended, the input control returns from the status 72 to a status 71-1.

Further, when the input device 10 is tilted at an angle greater than or equal to a predetermined angle in a predetermined direction in the status 72, the status 72 of the input control becomes “gesture: YES”, “sensor control: ON”, and “movement: scroll” as illustrated in the status 73. In this embodiment, a scrolling movement according to sensor control is performed in the status 73. Even after the swiping operation has ended in the status 73, the input control becomes “gesture: NO”, “sensor control: ON”, and “movement: scroll” as illustrated in the status 74. Accordingly, the scrolling movement is continued. Further, in the example of FIG. 7, the input control returns from the status 74 to the status 71 by returning the tilt of the input device 10 to an initial state (position). Thereby, the input control process ends. Note that the returning of the tilt of the input device 10 to the initial status (position) may be to return the tilt of the input device 10 in the status 10 or to return the tilt of the input device 10 to a predetermined angle for terminating the input control by the sensor 13.

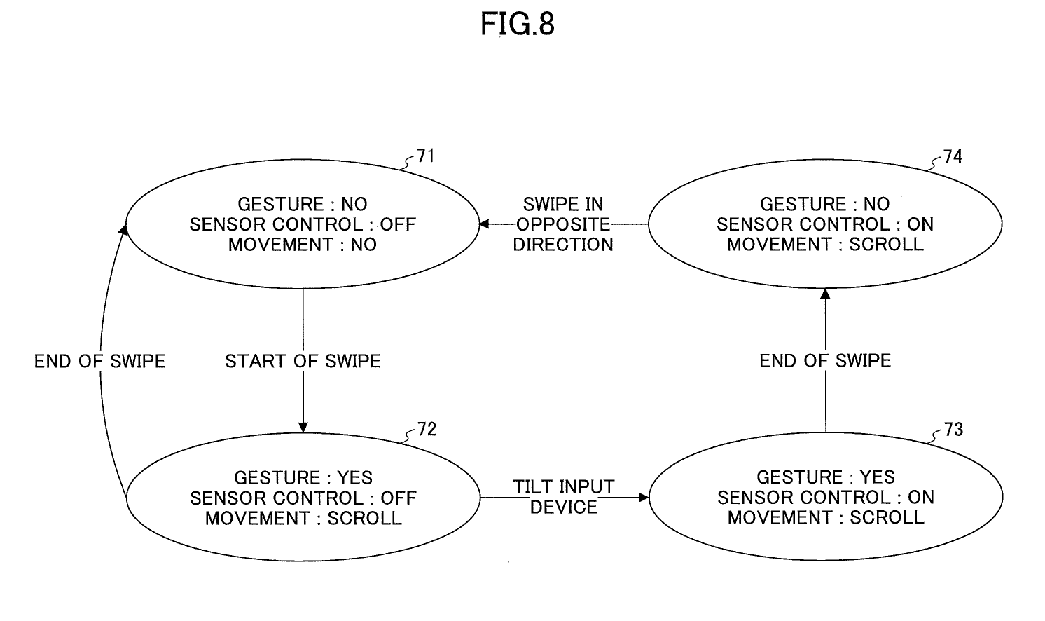

In the example of FIG. 8, the conditions for the transition from the status 74 to the status 71 is different compared to the example of FIG. 7. In the example of Fig. 8, when a swiping operation is performed in a direction opposite to the swiping direction in the initial status, the status 74 of the input control becomes “gesture: NO”, “sensor control: OFF”, and “movement: NO” as illustrated in the status 71. Thereby, the input control process ends.

That is, in the example of FIG. 8, a gesture operation is performed once again without tilting the input device 10 as illustrated in FIG. 7 for ending the continuation of the movement according to sensor control.

Note that the content of the gesture operation is not limited to performing the swiping operation in an opposite direction. For example, a gesture different from the gesture operation performed at the initial state (e.g., tapping, pinching-in, drawing a circle in the screen).

Note that, although FIGS. 7 and 8 illustrate examples of an input control process of continuing a scrolling movement by tilting the input device 10 during the scrolling movement in response to a swiping operation, the input control process is not to be limited to the examples described with FIGS. 7 and 8.

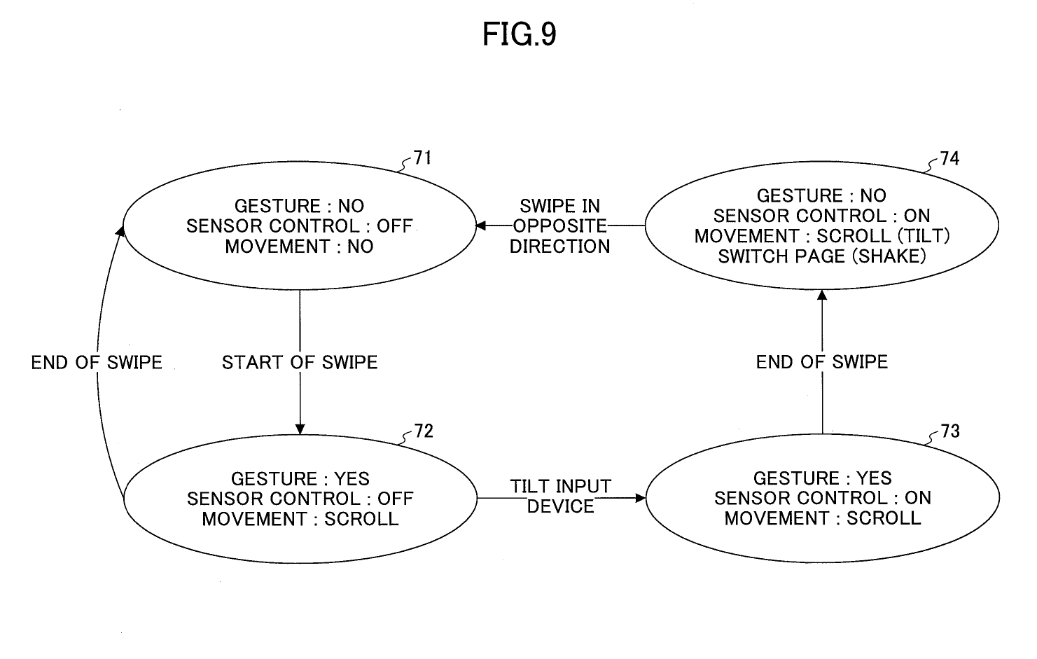

In the example of FIG. 9, the control content according to gesture detection and the control content according to movement detection of the input device 10 by the sensor 13 are different from the above-described examples of FIGS. 7 and 8. For example, when a swiping operation has ended in the status 73, the item “movement” of the status 73 changes from “scroll” to “switch page”, and a page of the contents displayed on the screen display unit 18 (e.g., contents of a book) is changed. Further, in the example of FIG. 9, the status 74 changes to the initial status 71 when the user performs a swiping operation in an opposite direction in a similar manner as the example of FIG. 8.

### Second Embodiment of Input Control Process

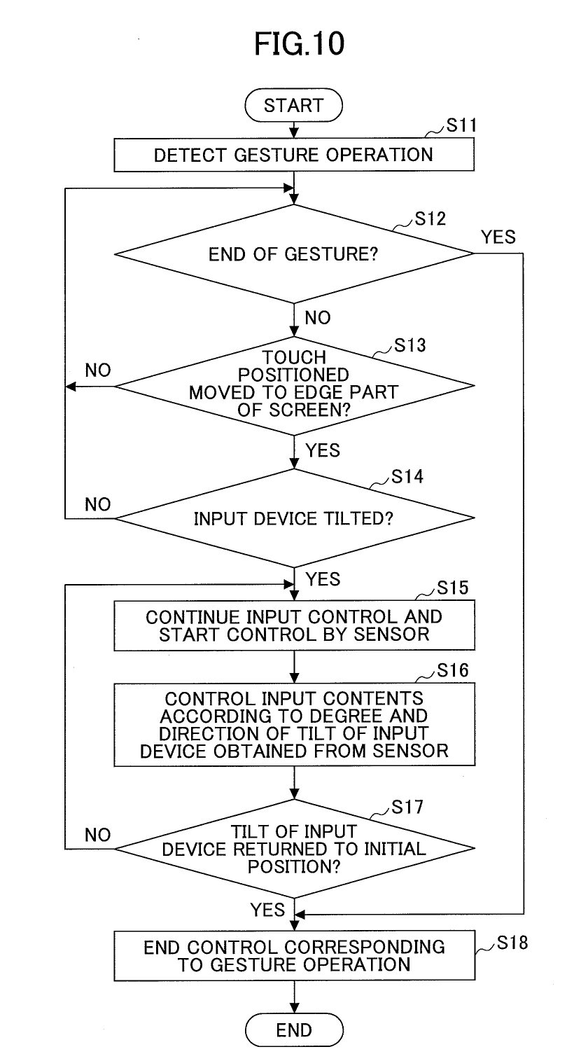

Next, the input control process of the input device 10 according to the second embodiment of the present invention is described with reference to the drawings. FIG. 10 is a flowchart illustrating an input control process of the input device 10 according to the second embodiment of the present invention. With the above-described input control process of the first embodiment, input control is performed by using the continuation time of the gesture operation and the tilt of the input device 10. With the following input control process of the second embodiment, in a case where a tilt of the input device 10 is detected at the time when a predetermined gesture operation is performed, the inputting of data corresponding to the gesture operation is continued. For example, with the second embodiment, input control is performed by using a touch position of a screen on which a gesture operation performed and a tilt of the input device 10.

In the example of FIG. 10, the input device 10 detects a gesture operation (e.g., swiping operation) by way of the gesture detection unit 12 in response to a user's input performed on the touch panel 11 (S11).

Then, the control execution unit 15 determines whether the gesture operation has ended (S12). Ina case where the gesture operation has not ended (NO in S12), the control execution unit 15 determines whether a touch position corresponding to the gesture has moved to the vicinity of an edge part of the screen (S13). That is, in the second embodiment, after a gesture operation for scrolling a screen (e.g., swiping) is started, the scrolling movement is continued as a continuous scroll in a case where the gesture operation is continued until a touch position corresponding to the gesture operation reaches the vicinity of the edge part of the screen (touch panel 11). Note that the “vicinity of the edge part” refers to, for example, a predetermined area of an edge part of the touch panel 11 (e.g., an outer frame area that is less than or equal to 1 cm from an edge of the touch panel 11). However, the “vicinity of the edge part” is not limited to the above. Further, the edge part is not limited to the edge part of the touch panel 11. For example, the edge part maybe an edge part of the contents displayed on a screen.

In a case where the touch position has not moved to the vicinity of the edge part of the screen (NO in S13), the control execution unit 15 returns to the process of S12. Further, in a case where the touch position has moved to the vicinity of the edge part of the screen (YES in S13), the control execution unit 15 determines whether the input device 10 is tilted (S14). In a case where the input device 10 is not tilted (NO in S14), the control execution unit 15 returns to the process of S12. Further, in a case where the input device 10 is tilted at angle greater than or equal to a predetermined angle α (YES in S14), the control execution unit 15 performs the processes of S15 and thereafter. Because the processes of S15 to

S18 are substantially the same as the above-described processes in S05 to S08, a detailed description of the processes of S15 to S18 is omitted.

With the second embodiment, a movement corresponding to a gesture can be controlled to continue by touching a predetermined position of a screen and moving the input device 10 during detection of the gesture by providing both the touch panel 11 and the sensor 13. Thereby, the screen can continue to scroll according to the input from the sensor without having to repeat the swiping operation. Thereby, the operability of a user's input to the input device 10 can be improved.

### Example of Input Operation According to Input Control Process of Second Embodiment

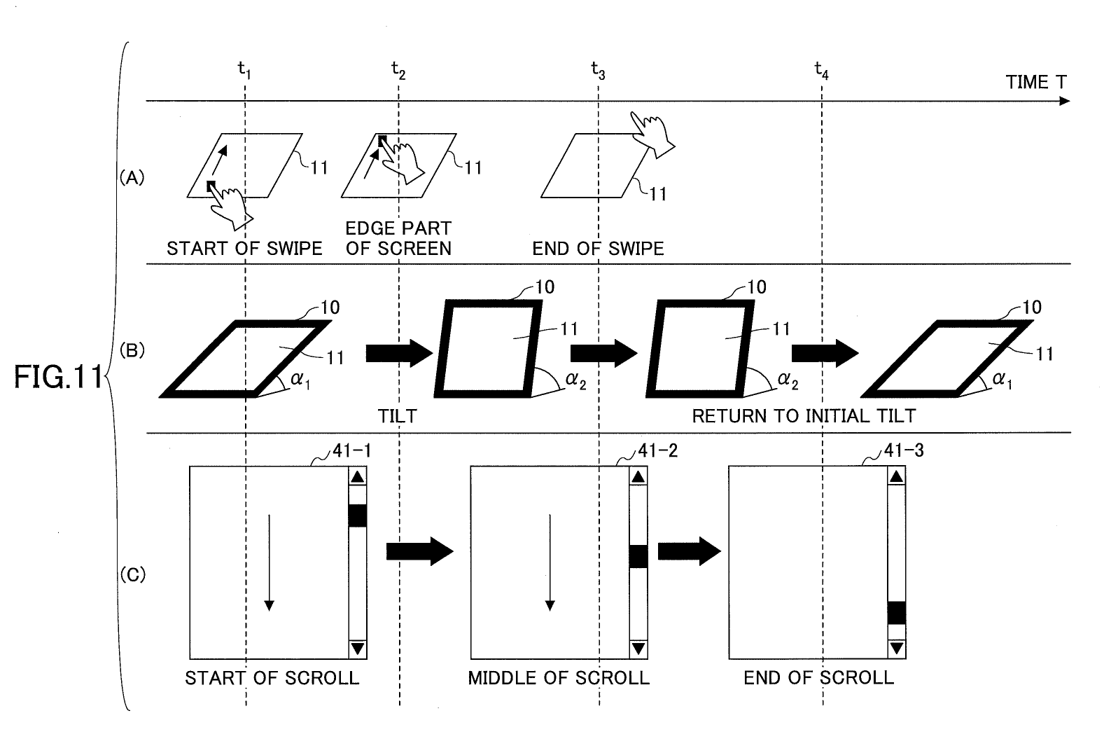

FIG. 11 is a schematic diagram for describing an example of an input operation according to the input control process of the second embodiment. (A) of FIG. 11 illustrates an example of a user's operation with respect to the touch panel 11 of the input device 10, (B) of FIG. 11 illustrates an example of a user's operation with respect to the input device 10, (C) of FIG. 11 illustrates an example of a contents screen 41 displayed on the screen display unit 18.

Note that, although (A) to (C) of FIG. 11 illustrate operations and movement occurring from time t₁ to t₄ during the same time period T, the operations and movement are not limited to the operation and movement illustrated in FIG. 11.

When the user swipes the touch panel 11 as illustrated in (A) of FIG. 11 (time t₁), a contents screen 41-1 scrolls in a downward direction in response to the swiping operation as illustrated in (C) of FIG. 11.

In the example of FIG. 11, the input device 10 is tilted at a predetermined angle (e.g., angle α₂) relative to the current reference angle (e.g., angle α in a predetermined direction when a touch position is moved to an edge part of a screen during the swiping operation (time t₂). The input device 10 detects the touch position in the touch panel 11 and the tilting movement of the input device 10 in a predetermined direction (e.g., tilt angle α₂-α₁).

Thereby, the control execution unit 15 continues the scrolling of the contents screen 41-2 even after the swiping operation has ended (time t₃) as illustrated in (B) of FIG. 11. Further, when the tilt of the input device 10 is returned to its initial position (e.g., angle α2 to α1) (time t₄), the scrolling of the contents screen 41-3 is ended as illustrated in (C) of FIG. 11.

In the example of FIG. 11, in a case of only performing the swiping operation without tilting the input device 10, the control execution unit 15 may start the scrolling of the screen when the swiping on the touch panel 11 is started, continue the scrolling until the touch position of the swiping operation reaches the edge part of the scrollable contents, and end the scrolling when the edge part of the contents is displayed on the screen.

With the above-described input control process, the user does not need to repeat the swiping operation for continuing the scrolling movement. For example, a scrolling movement or the like can be continued without having to repeat a swiping gesture.

### <Types of Applicable Controls and Types of Gestures and Sensors>

In this embodiment, multiple controls may be performed with a single movement (e.g., tilting the input device 10) by combining an input control based on gesture detection and input control based on movement detection by the sensor 13.

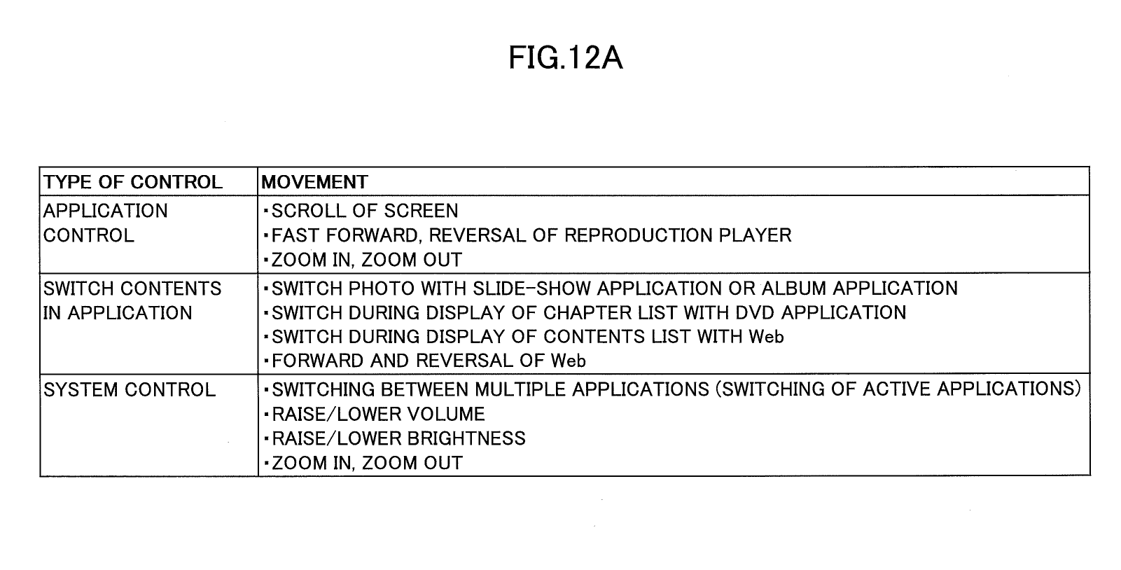

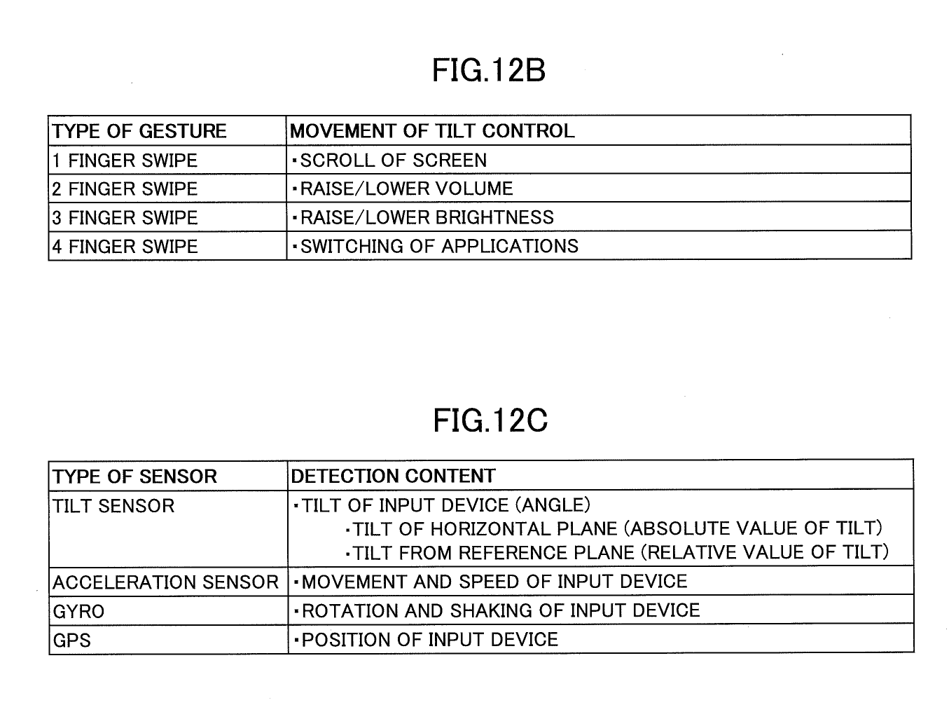

FIGS. 12A to 12C are schematic diagrams illustrating examples of the types of applicable controls and the types of gestures and sensors. FIG. 12A illustrates a relationship between the types of overall controls and the content of movements. FIG. 12B illustrates a relationship between types of gestures and the movements of tilt control in a case where multiple controls can be executed by a single movement (e.g., tilting the input device 10). FIG. 12C illustrates an example of movement detection according to a sensor.

This embodiment is suitable for a control that has the possibility of being continuously performed. For example, as illustrated in FIG. 12A, the item “application control” corresponds to processes such as the scrolling of a screen, fast-forwarding, rewinding, zooming in, and zooming out with a reproduction player (application control). Further, the item “switch contents in application” corresponds to processes such as the switching of photographs with a slideshow application or an album application, the switching of a displayed chapter list with a DVD application, the switching of a displayed contents list with a Web browser, and the forwarding or reversing of a Web page with a Web browser.

Further, the item “system control” corresponds to the switching between multiple applications (switching of active applications), the raising/lowering of volume, the raising/lowering of brightness, zooming in, and zooming out.

As illustrated in FIG. 12B, multiple controls can be executed by a single operation (e.g., tilting the input device 10) by the triggering of gesture detection.

As illustrated in FIG. 12B, for example, a screen can be scrolled by tilt control of the input device 10 after a swiping operation using a single finger. Similarly, the volume can be raised/lowered by a swiping operation using two fingers, the brightness can be raised/lowered by a swiping operation using three fingers, and applications can be switched by a swiping operation using four fingers. However, the operations and movements are not limited to the operations and movements illustrated in FIG. 12B. Information such as the number of fingers are detected by the gesture detection unit 12, and the control execution unit 15 performs control based on the information detected by the gesture detection unit 12.

Note that the gesture illustrated in FIG. 12B is not limited to a swiping operation. For example, the gesture may be an operation such as flicking, pinching in, pinching out, or rotating. Further, the gesture may be a gesture performed with a single finger or a gesture performed with multiple fingers or the like (multi-touch).

As illustrated in FIG. 12C, the movement detection by the sensor 13 may be performed by a control corresponding to the tilt (angle) of the input device 10 detected by a tilt sensor. Note that the tilt of the input device 10 may be a tilt relative to a horizontal plane (absolute value of tilt) or a tilt relative to a reference plane.

Further, the movement detection by the sensor 13 may include, for example, the detection of the movement or the velocity of the input device 10 by using an acceleration sensor, the detection of the rotation or shaking of the input device 10 by using a gyro sensor, the detection of the position of the input device 10 by using GPS. Based on the contents detected by the sensor 13, the control execution unit 15 can selectively execute the processes of FIG. 12A in correspondence with each detected content. Note that the types of controls or the like applicable to this embodiment are not limited to those illustrated in FIGS. 12A to 12C.

With the above-described embodiment, the operability of the input device 10 can be improved. For example, the operability of a user's input to the input device 10 can be improved by detecting the tilt of the input device 10 in the scrolling direction during an operation for scrolling and controlling the scrolling to continue.

Accordingly, the input device 10 can be operated without difficulty in a desired position while maintaining in an easily viewable for the user. Further, the input device 10 requires no additional operation buttons or the like as long as basic components of the input device 10 such as a touch panel and a sensor are provided in the input device 10.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An input device comprising:
a movement detector that detects a tilt of the input device during an input of information corresponding to a gesture operation; and
a controller that executes a control to continue the input of information after the gesture operation until the tilt detected by the movement detector becomes a predetermined status.

2. The input device as claimed in claim 1, further comprising:
an input unit that receives the input of information from a user; and
a gesture detector that detects the gesture operation according to the input received by the input unit;
wherein the controller is configured to determine whether to continue the input based on a detection result of the gesture detector and a detection result of the movement detector.

3. The input device as claimed in claim 1, wherein the controller is configured to continue the input in a case where the tilt of the input device is detected after a predetermined time has elapsed from the gesture operation.

4. The input device as claimed in claim 1, wherein the controller is configured to continue the input in a case where the tilt of the input device is detected at a timing when a predetermined operation is performed by the gesture operation.

5. The input device as claimed in claim 1, further comprising: a correction unit that corrects a condition of the tilt according to a time elapsed from the gesture operation, so that the input is continued by the controller.

6. The input device as claimed in claim 1, further comprising: an application execution unit that executes a predetermined application according to the input; wherein the controller is configured to execute a movement content according to a type of the application executed by the application execution unit.

7. A method for controlling an input device, the method comprising:
detecting a tilt of the input device during an input of information corresponding to a gesture operation; and
executing a control to continue the input of information after the gesture operation until the tilt detected by the detecting becomes a predetermined status.

8. A non-transitory computer-readable medium on which a program is recorded for causing a computer of an input device to execute a process, the process comprising:
detecting a tilt of the input device during an input of information corresponding to a gesture operation; and
executing a control to continue the input of information after the gesture operation until the tilt detected by the detecting becomes a predetermined status.
